(19) United States
(12) Patent Application Publication
(10) Pub. No.: US 2010/0136075 A1
(43) Pub. Date: Jun. 3, 2010

(54) METHOD FOR TREATING AN AT LEAST PARTIALLY METALLIZED TEXTILE, TREATED TEXTILE AND USE THEREOF

(75) Inventors: Detlef Militz, Hoppegarten (DE); Dieter Kreysig, Berlin (DE)

Correspondence Address: OUIMET LAW OFFICES, 1800 9TH AVENUE, # 1630, SEATTLE, WA, 98101, US

(73) Assignee: Detlef Militz, Hoppegarten (DE)

(21) Appl. No.: 12/664,384

(22) PCT Filed: Jun. 12, 2008
(86) PCT No.: PCT/EP2008/057441

§ 371 Date: Dec. 11, 2009

(30) Foreign Application Priority Data
Jun. 12, 2007 (DE) 10 2007 027 632.1

(51) Int. Cl. A01N 25/34; D06M 11/00

(52) U.S. Cl. 424/404; 8/115.54; 8/115.51

(57) ABSTRACT

The invention relates to a method for treating an at least partially metallised textile, according to which said textile is treated with at least one agent selected from the group consisting of reductants and complex formers. The invention also relates to a textile treated in this way and to the use thereof for the anti-microbial treatment of liquids or for producing hosiery, insoles, clothing, covers for seating furniture or mattresses. A textile that has been treated according to the invention is capable of an adjustable, purpose-specific metal delivery depending on the field of application.

The present invention relates to a method for treating an at least partially metallized textile. Further, the present invention relates to a textile obtained by the method according to the invention as well as the use thereof.

In the basic idea of the present patent application, a textile is for one-dimensional purposes, for example, a twine consisting of several yarns or a yarn which is formed as mono- or multifil filament yarn or as staple fiber yarn. For two-dimensional purposes, a textile is formed as textile sheet-like structure such as woven fabric, knitted fabric, interlacing, knitted yarns or as non-woven fabrics. Further, three-dimensional textiles having, for example, a textile sheet-like structure from which fiber portions extend transversally away from a plane of the textile sheet-like structure defined by the textile sheet-like structure are included.

At least partially metallized textiles are known in prior art. These metallized textiles are covered, whether completely or partially, with metal and, if required, metal ions. In principle, a textile can be metallized in the processing condition by textile manufacturing, in which it is employed into its application field. Alternatively, a textile can be also metallized and subsequently further processed by textile manufacturing. If required, that is made together with a further metallized or unmetallized textile.

Methods for metallizing textiles are known in prior art. For instance, U.S. Pat. No. 4,681,591 describes a method for producing a metallized polyester fiber textile material having the steps of: pre-treating the textile material having at least 15% by weight of polyester fibers with an aqueous solution of a caustic alkali, activation-treating the pre-treated textile material with a tin (II)-containing compound and with a palladium-containing compound and non-electrolytically plating the activation-treated textile material in a mixture containing nickel, copper, cobalt, chromium, or alloys thereof to form a metal coating thereon. A textile produced in such a way is suitable as electromagnetic radiation-shielding.

DE 34 19 755 A1 discloses a method for silver plating non-metallic materials. While doing so, a surface to be silver plated is activated with at least one compound on basis of palladium and subsequently silver plated by the use of a silver plating bath containing thiocyanate ions as complexing agent and hydroxylamine as reducing agent in addition to the silver salt.

JP 2005105386 A describes a bath for silver plating fibers. The bath contains a silver salt, a complexing agent, a stabilizing agent, and a reducing agent.

In JP 61281874, there is disclosed a method for metallizing polyester, wherein polyester is treated with caustic soda, sensibilized, activated and subsequently metallized with nickel or copper.

Further, in DE 10 2006 055763, there is disclosed a method for metallizing a polyester, wherein the polyester
is treated with an alkaline solution,
is treated with at least one compound selected from the group consisting of a primary amine, a secondary amine, a thiol, a sulphide, or an olefin,
is treated with a solution containing at least one metal salt selected from the group consisting of a silver salt, a copper salt, and a nickel salt, and at least one complexing agent, and
is treated with at least one reducing agent.

Disadvantageous to the methods described in the prior art is that due to an excessive use of metal salts and/or due to an incomplete conversion of metal salts to metals, metal salts which result in an increased and uncontrolled metal ion release during the use of the metallized material, for example, in a liquid remain in the metallized material. Especially, in regard to environmental and waste disposal considerations and also to the profitability of such materials, an uncontrolled release of metal or metal ions, respectively, is disadvantageous.

Especially, the uncontrolled and often too elevated release of metal or metal ions, respectively, into a liquid prevents the use of metallized textile in liquid-guiding systems, because such textiles do not meet the system guidelines or directives and regulations which have been issued, for example, for protection of the environment or the consumer by the EU such as the EU directive 98/83 for drinking water.

Therefore, it is an object of the present invention to provide a method for producing an at least partially metallized textile, wherein its metal release suitable to a purpose can be controlled depending on the application field according to the respective regulations, directives and/or system guidelines.

This object is solved by a method having the features of claim 1.

According to the invention, in a method for treating an at least partially metallized textile, the textile is treated with at least one agent selected from the group consisting of reducing agent and complexing agent.

The principles of activity of the agent are the reduction of ionic metal portions in the region of the surface of the at least partially metallized textile or the removal of ionic metal portions of the at least partially metallized textile by means of complexation, respectively. These strategies of action serve to prevent an uncontrolled high metal or metal ion release from the metallized textile to the environment, respectively.

Therefore, in the basic idea of the present invention, the method according to the invention serves as a method for reducing metal ions or for complexing metal ions, respectively, to effect a metal release suitable for a purpose, controlled depending on the application field. As a result, there are achieved not only a higher profitability, lower waste disposal costs and lower damage to the environment, but also a controlled sustained release during the application. A controlled sustained release during the application means that a metal release authorized according to the respective directives, system guidelines and regulations occurs constantly for a long period of time. Thereby, a long time of activity and, as a result, a long utilizability of the textile produced by means of the method according to the invention is obtained.

In a preferred embodiment, the agent is a reducing agent. Preferably, the reducing agent is selected from the group consisting of glucose, ascorbic acid, sodium dithionite, sodium borohydride, sodium thiosulphate, sodium sulphite, sodium formiate, formaldehyde, and sodium hydrophosphite. More preferably, the reducing agent is ascorbic acid. Even more preferably, the reducing agent is glucose. Glucose or ascorbic acid, respectively, is a very environmentally friendly reducing agent, easy to handle, easily available, water soluble, and admitted for use in foods. Preferably, the reducing agent is employed in aqueous or alcoholic solution for the treatment of the at least partially metallized textile. Subsequent to the treatment, the at least partially metallized textile is preferably washed and dried.

If the reducing agent is glucose, it is preferably employed in the form of an aqueous solution having a concentration from 1.25 to 5 g/l and a pH value in the range from 7 to 12, preferably, 8 to 10.5. For example, the pH value of the solution can be adjusted by means of addition of ammonia. The treatment of the at least partially metallized textile is carried out at a liquor ratio (ratio of the mass (kg) of the substrate to the volume (l) of the reducing agent solution) from 1:10 to 1:100, preferably 1:50 to 1:100. The at least partially metallized textile is moved in the reducing agent solution for 30 to 60 minutes at 50 to 60° C. Subsequent to the treatment with the reducing agent, the treated textile is preferably washed with water and, if required, dried at a temperature up to 140° C.

If the reducing agent is sodium borohydride, the reduction is preferably carried out in ethanol, especially at temperatures between 10° C. and 50° C., preferably 20° C. and 30° C., for a period of time between 15 and 60 minutes. Then, the treated textile is preferably washed with water and, if required, dried at a temperature up to 140° C.

In another preferred embodiment, the agent is a complexing agent. Preferably, the complexing agent is selected from the group consisting of ammonia, thiosulphate, thioisocyanate, ethylenediamine, triethanolamine, ethanolamine, 1,3-diaminopropane, glycerol, sodium tartrate, potassium sodium tartrate, and sodium citrate. Especially advantageously, the complexing agent is ammonia. Ammonia is easily volatile. Therefore, excessive ammonia can be easily removed. The at least partially metallized textile is rinsed with the complexing agent which can be in aqueous solution. If required, the treated textile is then washed with water and, if required, dried at a temperature up to 140° C.

In an alternative or additional embodiment, a polymer can be used as agent for treating an at least partially metallized textile. Preferably, the polymer is selected from the group consisting of polyurethane, polyacrylate, and finishing agent for high quality. The treatment of the at least partially metallized textile with a polymer includes the use of a polymer for partial or complete coating of the at least partially metallized textile, wherein adhesive agents or adhesive layers can be employed, if required. On the other hand, the treatment of the at least partially metallized textile with a polymer includes the application of at least one monomer to the at least partially metallized textile and polymerization of the at least one monomer. Methods for producing polymers, especially, polyacrylates and polyurethanes, are known by those skilled in the art. Also, methods for coating a textile with polymers are known by those skilled in the art.

As a rule, polyacrylates possess a controlled uptake and permeability for liquids, especially water, and allow therefore despite coating of the at least partially metallized textile an effect of the metal on the environment. Examples for polyacrylates comprise but are not limited to polyacrylic ester, polybutylacrylate, polyhydroxyalkylacrylate, and polymethylacrylate.

Preferably, the polyurethane is a polyurethane lacquer or polyurethane elastomer. A finishing agent for high quality includes common auxiliary agents, processing agents and additives as well as commercially available polymers and copolymers.

Preferably, the method is developed so that the at least partially metallized textile is a fiber system, the fiber system has an at least partially metallized yarn, wherein the at least partially metallized fiber material has been processed by textile manufacturing alone or together with additional fiber material to a fiber system before the treatment of the textile.

Then, the fiber material comprises at least one yarn and/or at least one twine. In the basic idea of the present invention, a fiber system can be formed one-dimensionally, two-dimensionally or three-dimensionally. For example, a one-dimensional fiber system is a twine. Two-dimensional fiber systems are textile sheet-like structures which can be especially formed as knitted fabric, woven fabric, knitted yarns, interlacing or non-woven fabric. For example, a three-dimensional fiber system is a spacer fabric.

On the one hand, there is the variant to process fiber material with at least one at least partially metallized yarn to a fiber system. Alternatively, additional non-metallized fiber material can be processed to the fiber system. On the other hand, non-metallized fiber material can be alternatively processed to a fiber system, wherein the fiber system is metallized at least partially only subsequently. Result of all production variants is always an at least partially metallized textile in form of a fiber system subjected subsequently to the treatment method described.

It turned out that the metal release of an at least partially metallized textile is influenced by each processing step by textile manufacturing of the at least partially metallized fiber material being contained therein. This has to do with the mechanical stress of the metallized surfaces of the fiber material. Inevitably, the mechanical stress is very high during the processing by textile manufacturing. If a metal release of the textile defined for the desired intended use should be adjusted by the treatment method, so it is preferred to avoid mechanical stresses of the metallized surfaces of the fiber material contained in the textile subsequent to the treatment. To put it in another way, it is preferred to finish the processing steps by textile manufacturing and the high mechanical stress of the fiber material surfaces related thereto before the treatment of the textile is carried out.

In a preferred embodiment, a silver plated polyamide yarn is processed with a non-metallized polyester yarn to a twine which is subsequently processed by means of a spacer warp knitting machine in the production of a spacer fabric. In this case the two yarns as fiber material are processed to a twine as one-dimensional fiber system which in turn is further processed to a spacer fabric as three-dimensional fiber system. Then, the twine can form both the whole spacer fabric and only individual regions of the spacer fabric. After having finished the above-mentioned processing steps by textile manufacturing, the spacer fabric is preferably subjected to the treatment method according to the invention.

Preferably, the processing of the fiber material by textile manufacturing to the fiber system comprises at least one of the processing techniques: twisting, weaving, knitting, and meshing. Usually, the fiber system produced in this way is cut to the desired dimensions, for example, by means of laser or plasma cutting devices.

In a preferred embodiment, the textile contains polyamide, polyester, polyolefin or mixtures thereof as well as, if required, one or more common auxiliary agents, processing agents or additives. In the basic idea of the present invention, polyamide, polyester or polyolefin, respectively, comprises both homopolymers and copolymers. Preferably, PA 6, PA 11, PA 12, PA 66, PA 46, PA 6/6T, PA 6/6I, PA 1212, PA 612, PA 6I, PA 6I/6T, PA MXDI/6I, PA MXDI/MXDT/6I/6T, PA MXDI/121, PA MACMI/12, PA MACMI/MACMT/12, 6I/MACMI/12, PA 6I/6T/MACMI/MACMT/12, PA PACM6/11, PA PACM12, PA PACMI/PACM12, PA MACM6/11, PA MACM12, PA MACMI/MACM12, PA MACM12/PACM12, PA 6I/6T/PACMI/PACMT/PACM12/612, especially preferably PA 6, PA 11, PA 12, PA 66 or PA 46, is employed as polyamide. Preferably, polyethylene terephthalate, polybutylene terephthalate, poly-1,4-cyclohexane dimethylene terephthalate, polyethylene oxybenzoate or poly-1,4-cyclohexylidene dimethylene terephthalate and mixtures thereof, especially preferably polyethylene terephthalate or polybutylene terephthalate is employed as polyester. Preferably, polypropylene or polyethylene, especially preferably polypropylene, is employed as polyolefin. The common auxiliary agents, processing agents or additives include but are not limited to stabilizing agents, flame retardants, processing aid agents, static inhibitors, antioxidant agents, plasticizers, coloring agents, impact strength modifying agents, adhesion modifying agents, pigments, reinforcing agents and/or fillers. Preferred examples for the common auxiliary agents, processing agents or additives include but are not limited to short glass fibers, glass beads, C fibers, silica, carbon black, chalk, mica, talc, baryte, mica, wollastonite, calcium carbonate, titanium dioxide, nanocomposites, graphite, MoS₂, silicates, aluminum, copper, bronze, steel, lead, zinc, nickel. Further, the term “additives” comprises also fiber materials of every kind which allow to be integrated by textile manufacturing in the at least partially metallized textile.

Preferably, in the method according to the invention, a textile coated at least partially with an oligodynamically active metal is employed as the at least partially metallized textile. Oligodynamically active metals include semi-precious and precious metals such as silver, copper, nickel, zinc and gold. A “textile coated at least partially with an oligodynamic metal” means a textile, wherein the oligodynamically active metal can be then provided whether in metallic form as particles bound into the textile structure or layers arranged onto the textile and, if required, in appropriate ionic form, for example, as metal salts in or on the textile. Of course, one or more intermediate layers can be arranged between the textile and the layer of oligodynamic metal.

The oligodynamically active metal confers to the textile an oligodynamic germicidal activity which is ensured on the one hand by the release of metal atoms and/or metal ions into the liquid surrounding the textile and on the other hand by a contact reaction of bacteria at the surface of the at least partially metallized textile. That is, besides the effect of the metal ions released into the water, the metal atoms or metal ions, respectively, not going into solution, being present at the fiber surface contribute—using heavily soluble metal salts—to the entire oligodynamic effect of the textile put at least partially in a liquid.

Also, objects of the present invention are the textile obtained by the method according to the invention and the use thereof.

Advantageously, the method according to the invention is employed with a metallized polyamide or polyester which is metallized in that the polyamide or polyester
is treated with an alkaline solution,
is treated with at least one compound selected from the group consisting of a primary amine, a secondary amine, a thiol, a sulphide, or an olefin,
is treated with a solution containing at least one metal salt selected from the group consisting of a silver salt, a copper salt, and a nickel salt, and at least one complexing agent, and
is treated with at least one reducing agent.

In the following, the above method for metallizing polyester or polyamide is referred to as a metallization method.

Preferably, in the metallization method, the alkaline solution is an aqueous and/or alcoholic solution containing sodium hydroxide or potassium hydroxide.

Preferably, in the metallization method, the compound selected from the group consisting of a primary amine, a secondary amine, a thiol, a sulphide, or an olefin is cross-linked prior to the further treatment with a solution containing a metal salt. The cross-linking of the compound can be realized by a self-cross-linking of the compound, for example, by condensation. Alternatively, the cross-linking of the compound can be realized by addition of at least one further compound and cross-linking with it, for example, by an addition.

Preferably, the at least one compound selected from the group consisting of a primary amine, a secondary amine, a thiol, a sulphide, and an olefin, is a compound of the Formula

(R¹O)ₓMR₄₋ₓ (I),

wherein
R¹ is a branched or straight-chain alkyl having 1 to 20 carbon atoms, preferably 1 to 10 carbon atoms, more preferably having 1 to 8 carbon atoms, even more preferably having 1 or 2 carbon atoms,
x is a number from 1 to 3, preferably 3,
M is Si, Ti or Sn, and
R is selected from the group consisting of CH₂CH₂CH₂NH₂, CH₂CH₂CH₂SH, CH═CH₂, (CH₂)ₚNH(CH₂)ₙNH(CH₂)ₗNH₂, and (CH₂)ₙNHₘ[(CH₂)ₗNH₂]ₖ,
p is an integer from 1 to 7, preferably 2 or 3,
n is an integer from 1 to 7, preferably 2 or 3,
m is zero, if k is 2, m is 1, if k is 1,
and l is an integer from 1 to 7, preferably 2 or 3,
   wherein in an even more preferred embodiment
R¹ is methyl, ethyl, propyl or butyl,
x is an integer from 1 to 3,
M is Si, Ti, or Sn, preferably Si, and
R is 1-aminopropyl, 1-mercaptopropyl, or vinyl.

Preferably, the metal salt is selected from the group consisting of silver halide, silver sulphate, silver nitrate, copper halide, copper sulphate, copper nitrate, copper acetate, nickel halide, nickel sulphate, nickel nitrate, and nickel acetate, wherein halide means chloride, bromide, or iodide, more preferably silver nitrate, silver chloride, or silver sulphate. The complexing agent and the reducing agent are the same as already mentioned above.

Especially preferably, the method according to the invention is employed with a metallized polyamide or metallized polyester which is metallized according to the above method, wherein the treatment with at least one compound selected from the group consisting of a primary amine, a secondary amine, a thiol, a sulphide, and an olefin, comprises
contacting the polyamide or polyester treated with an alkaline solution with at least one compound of the Formula (I),

(R¹O)ₓMR₄₋ₓ (I)

wherein
each R and R¹ is independently from each other a branched or straight-chain alkyl having 1 to 20 carbon atoms, preferably having 1 to 10 carbon atoms, more preferably having 1 to 8 carbon atoms, even more preferably having 1 or 2 carbon atoms, x is 1 to 4, and M is Si, Ti or Sn,
   optionally a first condensation,
   contacting with at least one compound of the Formula (I),
      wherein
R¹ is a branched or straight-chain alkyl having 1 to 20 carbon atoms, preferably 1 to 10 carbon atoms, more preferably 1 to 8 carbon atoms, even more preferably 1 or 2 carbon atoms,
x is 1 to 3, preferably 3,
M is Si, Ti or Sn, and
R is selected from the group consisting of CH₂CH₂CH₂NH₂, CH₂CH₂CH₂SH, CH═CH₂, (CH₂)ₚNH(CH₂)ₙNH(CH₂)ₗNH₂, and (CH₂)ₙNHₘ[(CH₂)ₗNH₂]ₖ,
p is an integer from 1 to 7, preferably 2 or 3,
n is an integer from 1 to 7, preferably 2 or 3,
m is zero, if k is 2,
m is 1, if k is 1,
and l is an integer from 1 to 7, preferably 2 or 3, and
   a second condensation.

In the metallization method, examples for a preferred compound of the Formula (I) comprise 3-aminopropyltriethoxysilane, 3-aminopropyltrimethoxysilane, 3-mercaptopropyltrimethoxysilane (3-trimethoxysilyl-1-propanethiol), triethoxyvinylsilane, N-(2-aminoethyl)-3-aminopropyltrimethoxysilane or 2-[2-(3-trimethoxysilylpropylamino)ethylamine]-ethylamine as functionalized alkoxysilane as well as tetraethoxysilane, tetramethoxysilane, triethoxyoctylsilane or triethoxymethylsilane as unfunctionalized alkoxysilane.

Further advantageously, the method according to the invention is employed with a metallized polyamide or metallized polyester which is metallized according to the above method, wherein the treatment with at least one compound selected from the group consisting of a primary amine, a secondary amine, a thiol, a sulphide, and an olefin comprises
contacting the polyamide or polyester treated with an alkaline solution with at least one compound of the Formula (I),

(R¹O)ₓMR₄₋ₓ (I)

wherein

R¹ is methyl, ethyl, propyl or butyl, x is 4, and M is Si, Ti or Sn,
a first condensation,
contacting with at least one compound of the Formula (I), wherein R¹ is methyl, ethyl, propyl or butyl, x is 1 to 3, M is Si, Ti or Sn, and R is 1-aminopropyl, 1-mercaptopropyl or vinyl, and
a second condensation.

In the metallization method, contacting the polyester or polyamide with a compound of the Formula (I) comprises a padding. For doing so, the compound of Formula (I) in a solvent such water and/or alcohol and, if required, hydrochloric acid, is applied to the polyamide or the polyester and then used by padding. The condensation comprises heating the polyester or polyamide treated with at least one compound of the Formula (I) up to 200° C., preferably up to 170° C., more preferably up to 140° C.

In another preferred embodiment, the method according to the invention is employed with a metallized textile which is metallized in that the textile
is treated with a compound having at least one amine group,
is treated with a compound having at least one functional group being suitable to perform an addition reaction with the amine group,
is treated with a solution containing at least one metal salt selected from the group consisting of a silver salt, a copper salt, and a nickel salt, and at least one complexing agent, and
is treated with at least one reducing agent, wherein the order of the first two steps is interchangeable.

In an advantageous embodiment of the invention, in the above method for metallizing a textile, the compound having at least one amine group is a liquid polyfunctional amine representing preferably a compound of the Formula

R²NHR³ (II),

wherein R² is selected from the group consisting of H₂N(CH₂)_{w}, R⁴₃Si(CH₂)_{w}, and H₂NC₆H₄,
R³ is selected from the group consisting of [(CH₂)ₓNH]_{y}(CH₂)₂NH₂, R₃Si(CH₂)_{y}, and H₂NC₆H₄NH(CH₂)_{y},
w is an integer from 1 to 7, preferably 2 or 3,
x is an integer from 1 to 7, preferably 2 or 3,
y is zero or an integer from 1 to 7, preferably zero, 1 or 2,
z is an integer from 1 to 7, preferably 2 or 3, and
R⁴ is a branched or straight-chain alkyl or -O-alkyl having 1 to 10 carbon atoms, preferably having 1 to 8 carbon atoms, more preferably having 1 or 2 carbon atoms.

Advantageously, the compound of the Formula (II) is selected from the group consisting of bis(3-aminopropyl)amine, N,N′-bis(2-aminoethyl)-1,3-propanediamine, triethylenetetramine, tetraethylenepentamine, bis[3-(trimethylsilyl)propyl]amine, and bis[3-(trimethoxysilyl)propyl]amine. Especially advantageously, the compound of the Formula (II) is bis(3-aminopropyl)amine or tetraethylenepentamine.

In an advantageous embodiment of the method for metallizing the textile, cross-linking the compound of the Formula (II) is carried out by contacting it with a compound having at least one isocyanate group, preferably two isocyanate groups. A compound of the Formula (II) performs with a compound having at least one isocyanate group an addition reaction by formation of a urea. Advantageously, the compound having at least one isocyanate group is a diisocyanate. Preferably, the diisocyanate is selected from the group consisting of hexamethylene diisocyanate, tolylene diisocyanate, isophorone diisocyanate, and 4,4′-methylene-bis(cyclohexyl isocyanate). Especially preferably, the diisocyanate is hexamethylene diisocyanate. To perform a cross-linking of the compound having at least one amine group with a compound having at least one isocyanate group, the textile is coated with the compound having at least one amine group, if required, used by padding, and subsequently coated with a compound having at least one isocyanate group and, if required, used by padding. Of course, the order of coating is free to choose. Optionally, the adequate compound can be solved in a solvent, preferably water.

Alternatively, an addition reaction of the compound having at least one amine group is carried out by contacting with it a compound having at least one epoxide group. Examples for a compound having one epoxide group are propyleneoxide, styreneoxide, 4-vinyl-1-cyclohexene-1,2-epoxide, 2,3-dimethyl-2,3-epoxybutane, and limonene-1,2-epoxide. Then, the compound having at least one epoxide group can be solved in a solvent. An aprotic solvent, preferably an ether or, if required, a chlorinated hydrocarbon is selected as solvent. For carrying out the addition reaction, the textile which whether was already treated or is subsequently treated with a compound having at least one amine group is sprayed with, wetted with, immersed in or put in a compound having at least one epoxide group.

Preferably, in the method for metallizing the textile by use of an addition reaction of a compound having at least one amine, the metal salt is selected from the group consisting of silver halide, silver sulphate, silver nitrate, copper halide, copper sulphate, copper nitrate, copper acetate, nickel halide, nickel sulphate, nickel nitrate, and nickel acetate, wherein halide means chloride, bromide, or iodide, more preferably silver nitrate, silver chloride, or silver sulphate. The complexing agent and the reducing agent are the same as already mentioned above.

Especially preferred, the at least partially metallized textile employed in the method according to the invention is a silver plated textile. In a preferred embodiment, a silver plated textile is treated by means of glucose as the reducing agent. The reducing action of aqueous solutions of glucose is dependent on the glucose concentration and the redox potential dependent on the pH among other. For a textile which is treated with 0.5% of glucose solutions (being referred to as standard herein below) at 60° C. for one hour results in a redox potential dependent linearly on the pH value
from −25 mV for pH 7.5 and −275 mV for pH 12;
for the treatment with 1% of glucose solution from ±0 mV for pH 6.8 to −225 mV for pH 12.

The silver release of the silver plated standard material after the treatment decreases linearly with increasing pH value of the reducing solution and with increasing oxidation potential:

| | |
|---|---|
| from 185 μg of Ag/l for pH 7.5 | to 20 μg of Ag/l for pH 12 and |
| from 185 μg of Ag/l for −20 mV | to 14 μg of Ag/l for −280 mV, |
| respectively. | |

That is, by treating the at least partially metallized textile by the method according to the invention, the metal or metal ion release, respectively, in this case the silver or silver ion release, respectively, of the metallized textile in a surrounding liquid can be adjusted to a determined value.

In a preferred embodiment, the textile is formed as a yarn, a twine, a woven fabric, a knitted fabric, an interlacing, knitted yarns or a non-woven fabric. Especially preferred, the at least partially metallized textile is a spacer fabric. In another especially preferred embodiment, the at least partially metallized textile is a spacer fabric having only on one of its surfaces an at least partially metallized fiber material.

A textile obtained by using the method according to the invention is suitable for an antimicrobial treatment of a liquid in a liquid-guiding system. Especially, a silver plated textile is suitable for it, since due to its excellent antimicrobial effect, silver is capable to effectively inhibit especially bacteria, fungi and micro algae.

Alternatively, the textile obtained by the method according to the invention is used for producing socks, insoles, clothing, covering textiles for seating furniture or mattresses. Also, in this case, due to the particular powerful oligodynamic properties, a silver plated textile is especially suitable.

Especially, the textile obtained by the use of the method according to the invention is employed in the treatment of a liquid in the form of a process liquid or in the form of drinking water. These liquids can be in systems being closed or open to the surrounding atmosphere, stagnating or circulating, in power stations, industrial or commercial plants or air conditioners. In each case, the metal elution of the textile according to the invention can be individually adjusted in such a manner that, for example, during the use for treating liquid in the form of drinking water distinct national directives in regard to the maximum authorized metal concentration in drinking water are met.

The term of the “process liquid” serves as a generic term for a liquid which fulfils one or more functionalities such as cooling, lubricating, hydraulically switching, and controlling or is consumed as service or industrial liquid.

A preferred use is the antimicrobial treatment of a liquid in a liquid-guiding system comprising the treatment of a liquid cooling lubricant in the cooling lubricant circulation of a metal-working plant. Such cooling lubricating liquids are generally employed in industrial and commercial plants working metals by intervention on the substance such as turning, milling or drilling. The use is especially advantageous, if the cooling lubricating liquid is employed as water-oil-emulsion in a cooling lubricating liquid system. Thereby, the cooling lubricating liquid remains microbiologically stable without the need of the usual biocides so far, particularly on basis of formaldehyde. This leads to lower health stress of the operating staff and lower costs by higher service life. By means of the method according to the invention, the release of antimicrobial acting metal components can be optimally adjusted to the requirements.

A further preferred use is the antimicrobial treatment of a liquid in a liquid-guiding system comprising the treatment of a liquid switching medium in a hydraulic switching circuit of an industrial plant. Also, in hydraulic switching circuits, biological mass growth can be a problem. Especially, this applies for circuits having regions through which material which is suitable as food for a lot of micro organisms comes regularly into the hydraulic medium. For example, this applies for plants contacting cellulose containing materials. Also, this applies for materials having natural fibers like cotton, linen, wool, etc. Thus, the method is especially advantageously employable, where the industrial or commercial plant is formed as paper producing and/or processing plant or as plant for producing and/or processing textiles. Also, as mentioned above, the adjustment of the elution of oligodynamically active metal ions tailored to requirements is given in this case.

A further preferred use is the antimicrobial treatment of a liquid in a liquid-guiding system in a washing apparatus for laundry comprising the treatment of remained laundry rinsing water. In this way, it is possible to store remained laundry rinsing water in a tank without risking that this water becomes unsuitable due to microbial activity in the long run. Especially, this is true at a time, if, for example, substances being a good nutrimental basis for microorganisms are washed out, while rinsing the laundry. Especially, that is the case, when washing natural fiber textiles. Thus, it is particular advantageous that the treated laundry rinsing water will be employed as washing water for a newly starting washing step of the washing apparatus. By the fact that, f. e., the rinsing water of the last rinsing procedure in washing machines is stored for the use as first washing water in a new washing step, a further reduction of the water consumption of washing machines can be realized in an easy manner. This effect can be adopted to further washing apparatuses and washing processes for different laundries.

A further preferred use is the antimicrobial treatment of a liquid in a liquid-guiding system in a medical technical device comprising the treatment of sterile process water. Then, there is a regular need to ensure high requirements in regard to an enduring sterility of the water and a piping system coming in contact therewith.

This can be ensured in an easy and reliable manner by using a three-dimensional fiber system having oligodynamic activity.

Further features and advantages of the invention are explained in connection with the description of examples. However, the present invention is not limited to the examples explained below.

### EXAMPLE 1

150 ml of aqueous 1.25 g/l of glucose solution was brought to a pH value of 9 by addition of ammonia. 1 g of silver plated textile made of polyamide was put in the glucose solution and treated for 1 hour at 60° C., rinsed with water and dried.

1 g of textile so obtained was put in 100 ml of water and shaken for 72 hours. A measurement of the silver release of the textile into the water was done by atomic absorption spectrometry. The measurement shows a release of 80 μg of silver per liter of water.

### EXAMPLE 2

150 ml of aqueous 5 g/l of glucose solution was brought to a pH value of 9 by addition of ammonia. 1 g of silver plated textile made of polyamide was put in the glucose solution and treated for 1 hour at 60° C., rinsed with water and dried.

1 g of textile so obtained was put in 100 ml of water and shaken for 72 hours. A measurement of the silver release of the textile into the water was done by atomic absorption spectrometry. The measurement shows a release of 4 μg of silver per liter of water.

### EXAMPLE 3

A vessel surrounded by heating mats and heating sleeve (size: 1 m³) was completely lined with silver plated 3D spacer fabric made of polyamide/polyester treated with glucose solution, filled with water, heated up to 45° C. and hold constantly at the temperature of 45° C. The silver amount of the water was determined quantitatively for a period of time of 47 days. The results are shown in table 1.

### COMPARISON EXAMPLE

A vessel surrounded by heating mats and heating sleeve (size: 1 m³) was completely lined with silver plated 3D spacer fabric made of polyamide/polyester which was not subjected to the method according to the invention, filled with water, heated up to 45° C. and hold constantly at the temperature of 45° C. The silver amount of the water was determined quantitatively for a period of time of 47 days. The results are shown in table 1.

TABLE 1
Table 1: Solved silver in microgram/liter of water

| | Example 3 | Comparison Example |
|---|---|---|
| | μg of silver/l of | μg of silver/l of |
| Day | water | water |
| 1 | 13 | 348 |
| 14 | 53 | 1047 |
| 21 | 61 | 1271 |
| 26 | 65 | 2780 |
| 28 | 69 | 2598 |
| 33 | 64 | 2275 |
| 40 | 53 | 2594 |
| 47 | 45 | 2825 |

As can be seen from table 1, the silver elution according to Example 3 is significantly lower than the silver elution according to the Comparison Example. The silver ion concentration according to Example 3 is in the range of 45 to 69 μg of Ag/l of water, whereas the silver ion concentration according to the Comparison Example increases continuously and has at the end of the experiment a value of about 2.800 μg of Ag/l of water. Table 1 shows that it is possible to control the release of silver ions into water in a limiting way by treating silver plated 3D material with glucose solution.

In the Examples and Comparison Examples, the taking of a water sample was performed according to DIN 38402 A 14. The measurements for determination of silver were performed by means of a Varian GTA 96 (Graphite Tube Atomizer) spectrometer according to DIN 38406 (E18) Part 18. The evaluation of the measurements was based on DIN ISO 8466-2.

1. A method for treating an at least partially metallized textile, wherein
the textile is treated with at least one agent selected from the group consisting of reducing agent and complexing agent,
wherein the at least partially metallized textile is a textile coated at least partially with an oligodynamically active metal and the oligodynamically active metal is selected from the group consisting of silver, copper, zinc, and gold.

2. The method according to claim 1, wherein the reducing agent is selected from the group consisting of glucose, ascorbic acid, sodium dithionite, sodium borohydride, sodium thiosulphate, sodium sulfite, sodium formiate, formaldehyde, and sodium hydrophosphite.

3. The method according to claim 1, wherein the complexing agent is selected from the group consisting of ammonia, thiosulphate, thioisocyantate, ethylenediamine, triethanolamine, ethanolamine, 1,3-diaminopropane, glycerol, sodium tartrate, potassium sodium tartrate, and sodium citrate.

4. The method according to claim 1, wherein the at least partially metallized textile is in the form of a fiber system, the fiber system has an at least partially metallized yarn, wherein the fiber system is processed by textile manufacturing alone or together with additional fiber material to a fiber system before the treatment of the textile.

5. The method according to claim 4, wherein the processing by textile manufacturing comprises twisting, weaving, knitting, and meshing.

6. The method according to claim 1, wherein the textile contains polyamide, polyester, polyolefin or mixtures thereof and, if required, one or more common auxiliary agents, processing agents or additives.

7. The method according to claim 1, wherein the oligodynamically active metal is selected from the group consisting of silver, and copper.

8. A textile obtained by the method according to claim 1.

9. The textile according to claim 8, wherein it is formed as a yarn, a twine, a woven fabric, a knitted fabric, an interlacing, knitted yarns or a non-woven fabric.

10. A use of a textile obtained by the method according to claim 1 for an antimicrobial treatment of a liquid in a liquid-guiding system or for a production of socks, insoles, clothing, covering textiles for seating furniture or mattresses.

11. The use according to claim 10, wherein the antimicrobial treatment of a liquid in a liquid-guiding system comprises the treatment of drinking water or process water in systems being closed or open to the surrounding atmosphere, stagnating or circulating, in power stations, industrial or commercial plants or air conditioners.

12. The use according to claim 10, wherein the antimicrobial treatment of a liquid in a liquid-guiding system comprises the treatment of a liquid cooling lubricant in the cooling lubricant circulation of a metal-working plant.

13. The use according to claim 10, wherein the antimicrobial treatment of a liquid in a liquid-guiding system comprises the treatment of a liquid switching medium in a hydraulic switching circuit of an industrial plant.

14. The use according to claim 10, wherein the antimicrobial treatment of a liquid in a liquid-guiding system in a washing apparatus for laundry comprises the treatment of retained laundry rinsing water.

15. The use according to claim 10, wherein the antimicrobial treatment of a liquid in a liquid-guiding system in a medical technical device comprises the treatment of sterile process water.
